(19) United States
(12) Patent Application Publication
(10) Pub. No.: US 2015/0134590 A1
(43) Pub. Date: May 14, 2015

(54) NORMALIZING AMORPHOUS QUERY RESULT SETS

(71) Applicant: International Business Machines Corporation, Armonk, NY (US)

(72) Inventors: TAMER E. ABUELSAAD, Somers, NY (US); Gregory Jensen Boss, Saginaw, MI (US); Craig Matthew Trim, Sylmar, CA (US); Albert Tien-Yuen Wong, Whittier, CA (US)

(73) Assignee: International Business Machines Corporation, Armonk, NY (US)

(21) Appl. No.: 14/076,673

(22) Filed: Nov. 11, 2013

(51) Int. Cl. G06F 17/30; G06N 7/00

(52) U.S. Cl. CPC G06F 17/30563; G06N 7/00
USPC 707/602

(57) ABSTRACT

A method, system, and computer program product for normalizing amorphous query result sets are provided in the illustrative embodiments. A property of data in a portion of the result set is identified. the property is usable for normalizing the portion into a structured data. Based on the property, the portion is categorized into a first category as a candidate for normalization using a first structure specification. The portion is transformed, responsive to the first category being selected for normalizing the portion over a second category in an evaluation, into the structured data according to the first structure specification of the first category. The structured data and a metadata of structure specification are added to a normalized result set. The normalized result set is output to a consumer application.

### TECHNICAL FIELD

The present invention relates generally to a method, system, and computer program product for post processing of data resulting from querying data. More particularly, the present invention relates to a method, system, and computer program product for normalizing amorphous query result sets.

### BACKGROUND

A data store is a repository of amorphous data. Generally, amorphous data is data that does not conform to any particular form or structure. Typically, data sourced from several different sources of different types is amorphous because the sources provide the data in varying formats, organized in different ways, and often in unstructured form.

A data cube is a quantum of data that can be sold, purchased, borrowed, installed, loaded, or otherwise used in a computation. Several methods for querying amorphous data from one or more data stores are presently in use. Presently, the amorphous data that is to be queried is first organized in a data structure with a suitable number of columns to represent all of the amorphous data, e.g., as a multi-dimensional data cube, using any known technique for constructing such data structures. A query is then constructed corresponding to the dimensions represented in the data structure.

Querying amorphous data produces a result set that is also amorphous. A result set is data resulting from executing a query.

Normalization of data is a process of organizing the data. Structuring unstructured data, for example, casting or transforming amorphous data into some structured form, is an example of normalizing amorphous data.

### SUMMARY

The illustrative embodiments provide a method, system, and computer program product for normalizing amorphous query result sets. An embodiment includes a method for normalizing an amorphous query result set. The embodiment includes identifying a property of data in a portion of the result set, wherein the property is usable for normalizing the portion into a structured data. The embodiment includes categorizing, into a first category, based on the property, the portion as a candidate for normalization using a first structure specification. The embodiment includes transforming, responsive to the first category being selected for normalizing the portion over a second category in an evaluation, the portion into the structured data according to the first structure specification of the first category. The embodiment includes adding the structured data and a metadata of structure specification to a normalized result set. The embodiment includes outputting the normalized result set to a consumer application.

Another embodiment includes a computer program product for normalizing an amorphous query result set. The embodiment includes one or more computer-readable tangible storage devices. The embodiment includes program instructions, stored on at least one of the one or more storage devices, to identify a property of data in a portion of the result set, wherein the property is usable for normalizing the portion into a structured data. The embodiment includes program instructions, stored on at least one of the one or more storage devices, to categorize, into a first category, based on the property, the portion as a candidate for normalization using a first structure specification. The embodiment includes program instructions, stored on at least one of the one or more storage devices, to transform, responsive to the first category being selected for normalizing the portion over a second category in an evaluation, the portion into the structured data according to the first structure specification of the first category. The embodiment includes program instructions, stored on at least one of the one or more storage devices, to add the structured data and a metadata of structure specification to a normalized result set. The embodiment includes program instructions, stored on at least one of the one or more storage devices, to output the normalized result set to a consumer application.

Another embodiment includes a computer system for normalizing an amorphous query result set, the computer system comprising. The embodiment includes one or more processors, one or more computer-readable memories, and one or more computer-readable tangible storage devices. The embodiment includes program instructions, stored on at least one of the one or more storage devices for execution by at least one of the one or more processors via at least one of the one or more memories, to identify a property of data in a portion of the result set, wherein the property is usable for normalizing the portion into a structured data. The embodiment includes program instructions, stored on at least one of the one or more storage devices for execution by at least one of the one or more processors via at least one of the one or more memories, to categorize, into a first category, based on the property, the portion as a candidate for normalization using a first structure specification. The embodiment includes program instructions, stored on at least one of the one or more storage devices for execution by at least one of the one or more processors via at least one of the one or more memories, to transform, responsive to the first category being selected for normalizing the portion over a second category in an evaluation, the portion into the structured data according to the first structure specification of the first category. The embodiment includes program instructions, stored on at least one of the one or more storage devices for execution by at least one of the one or more processors via at least one of the one or more memories, to add the structured data and a metadata of structure specification to a normalized result set. The embodiment includes program instructions, stored on at least one of the one or more storage devices for execution by at least one of the one or more processors via at least one of the one or more memories, to output the normalized result set to a consumer application.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of a configuration for normalizing amorphous query result sets in accordance with an illustrative embodiment;

FIG. 4 depicts a block diagram of an example application for normalizing amorphous query result sets in accordance with an illustrative embodiment;

FIG. 5 depicts a flowchart of an example process for normalizing amorphous query result sets in accordance with an illustrative embodiment;

FIG. 6 depicts a process for enriching a decision framework for normalizing amorphous query result sets in accordance with an illustrative embodiment; and

FIG. 7 depicts a flowchart of an example process for identifying a structure by data inspection in accordance with an illustrative embodiment.

### DETAILED DESCRIPTION

Much like an application store contains applications, a data store according to the illustrative embodiments contains numerous data cubes. In a manner similar to obtaining an application from an application store for use on a device, a user can obtain one or more data cubes to use in the user's query. For example, a user can use a shopping cart application to select data cubes from a data store. The user can then buy, borrow, download, install, or otherwise use the selected data cubes in the user's query in the manner of an embodiment.

The illustrative embodiments recognize that the type and number of structures resulting from a normalization process are dependent upon the nature of the data being normalized. Normalization of amorphous data can result in one or more structures of one or more types.

Extensible Markup language (XML), relational table, ontology, comma separated values (CSV), and Resource Description Framework (RDF) are some examples of the structures for representing structured data. A normalized amorphous result set according to an embodiment can take the form of these or any other suitable structure for representing structured data. Furthermore, an embodiment can produce more than one normalized form of amorphous result set, such as alternate structures representing the result set, different structures representing different portions of the result set, or a combination thereof.

The illustrative embodiments recognize that presently available methods to query heterogeneous data, such as using data cubes constructed from heterogeneous data, first normalize the data to be queried into a common structure. The query methods then perform queries in a standardized format compatible with the normalized structure of the input data.

The illustrative embodiments recognize that such methods are acceptable for finite or limited input data to produce usable output data. The illustrative embodiments recognize that under certain circumstances, the presently available query methods produce result sets that are too amorphous for meaningful use or reuse. For example, some of these circumstances present themselves when the input data is sourced from different sources and has no common ownership, or where the number of data cubes in a data store exceeds a certain quantity, for example, hundreds of thousands of data cubes, or where there is no way to anticipate which data cubes will be requested to be joined for a query. In these and other such forward looking circumstances, traditional query methods produce unstructured amorphous result sets.

Furthermore, the illustrative embodiments recognize that because the presently available methods to query heterogeneous data first normalize data, mixed structures can be present in input data as well as output data. Having a mix of structures in the output result set is almost similar to having amorphous data in the result set in the problems they pose during the consumption of the result set.

The illustrative embodiments recognize that presently there is no known method to deal with query output result sets that are truly amorphous or are pseudo-amorphous for containing mixed data formats within the result sets. The illustrative embodiments recognize that the amorphous or pseudo-amorphous result sets (hereinafter collectively referred to as “amorphous result set” unless specifically distinguished where uses) produced in this manner cannot be used in a consumer application without some intervention and normalization of the result set.

The illustrative embodiments used to describe the invention generally address and solve the above-described problems and other problems related to amorphous result sets. The illustrative embodiments provide a method, system, and computer program product for normalizing amorphous query result sets.

An embodiment determines one or more suitable data formats or structures to use for transforming an amorphous result set of a query execution. An embodiment takes the output of a query execution and applies one or more analysis techniques to determine or predict a data format with which to normalize the result set such that the normalized result set is useable for the intended consumption.

An embodiment further segments the result set, such as to normalize using more than one structures or data formats. Another embodiment caches the determined structures for future queries of a similar nature, using similar data stores, for similar consumers, or a combination thereof. Another embodiment augments the result set structure with metadata that facilitates the consumption of the normalized result set in some data processing environments.

The illustrative embodiments are described with respect to, certain data formats, structures, inputs, outputs, data processing systems, environments, components, and applications only as examples. Any specific manifestations of such artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

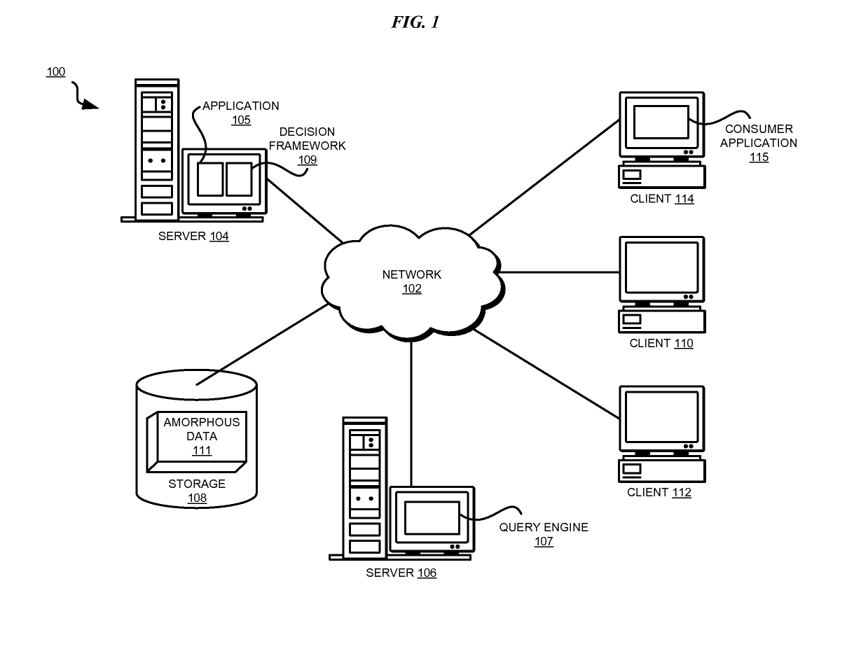

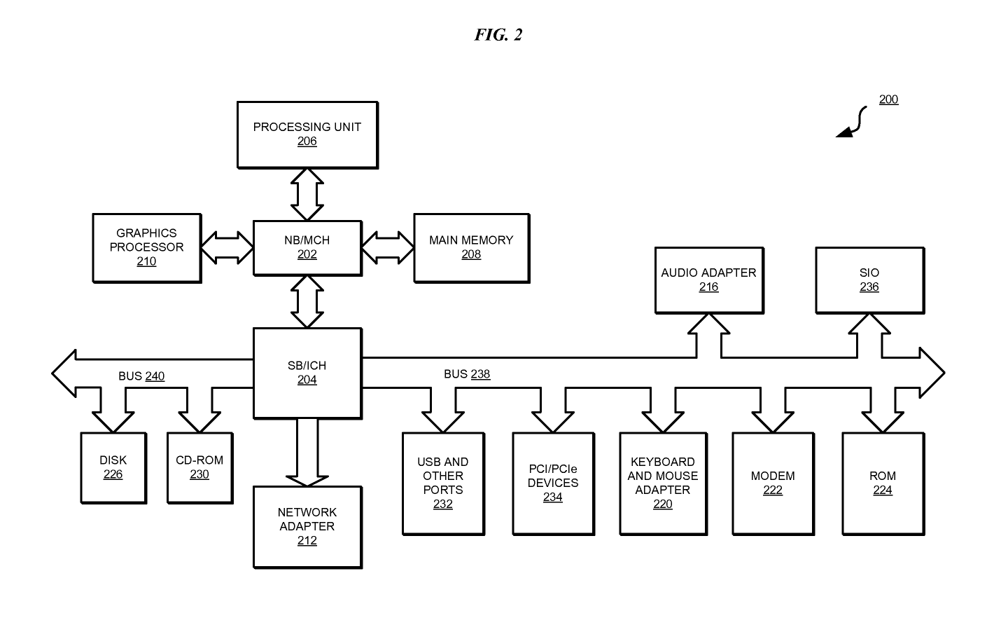

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Only as an example, and without implying any limitation to such architecture, FIG. 1 depicts certain components that are useable in an embodiment. Application 105 in server 104 implements an embodiment described herein. Query engine 107 can be located in the same or different data processing system as application 105. As an example, query engine 107 operates in server 106 and uses amorphous data 111, which comprises one or more data cubes, to generate the result set processed by application 105. Application 105 uses decision framework 109 according to an embodiment to normalize the result set. Consumer application 115 receives the normalized result set from application 105.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, or another type of device in which computer usable program code or instructions implementing the processes may be located for the illustrative embodiments.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 105, query engine 107, decision framework 109, and consumer application 115 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA) or another mobile computing device, which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

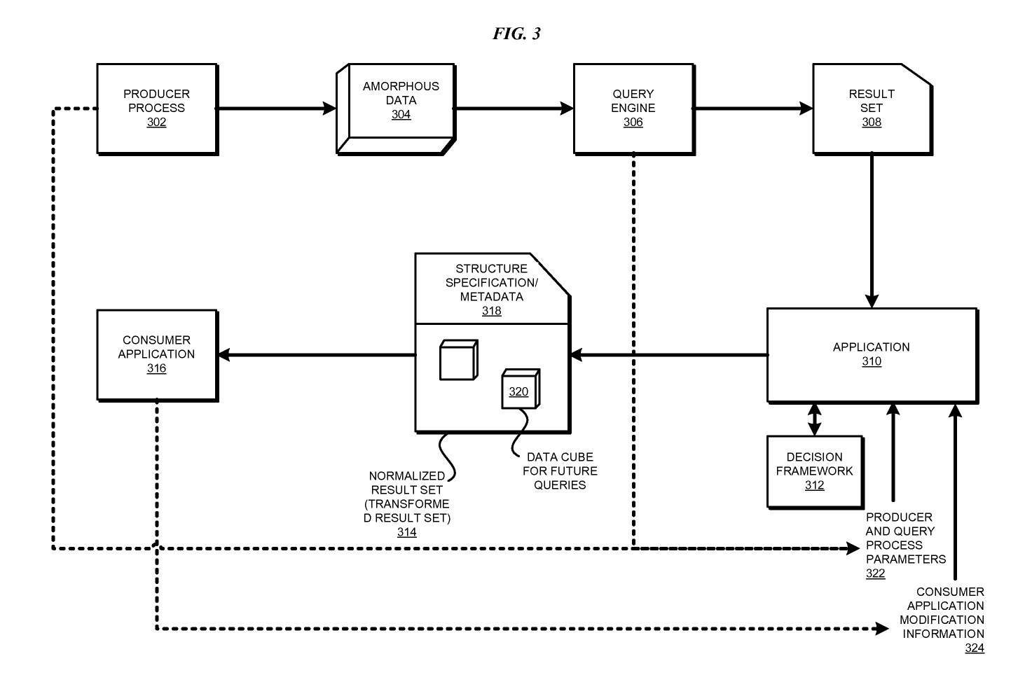

With reference to FIG. 3, this figure depicts a block diagram of a configuration for normalizing amorphous query result sets in accordance with an illustrative embodiment. Amorphous data 304 is an example of amorphous data 111 in FIG. 1. Query engine 306 is an example of query engine 107 in FIG. 1. Application 310 is an example of application 105 in FIG. 1. Consumer application 316 is an example of consumer application 115 in FIG. 1.

Producer process 302 can be any process or source that produces data for, or contributes data to, amorphous data 304, which exists in the form of one or more data cubes. Query engine 306 uses amorphous data 304 to produce result set 308. Amorphous data 304 may be normalized before query engine 306 uses data 304 as input data for a query.

Result set 308 includes amorphous or pseudo-amorphous data. Application 310 processes result set 308 according to an analytic method selected from decision framework 312. Application 310 produces normalized result set 314. Consumer application 316 consumes normalized result set 314.

In some embodiments, application 310 produces normalized result set 314 with additional information. For example, in one embodiment, normalized result set 314 further includes metadata 318. Metadata 318 can be specified in the same of different document or container as normalizes result set 314.

In one embodiment, metadata 318 includes provenance indicators of one or more producer process 302 who contribute at least some of the data to result set 308. Provenance of a producer process, such as of producer process 302, can change how consumer application 316 consumes normalized result set 314.

In another embodiment, metadata 318 includes structure specification of the structure used to normalize all or part of normalized result set 314. For example, an embodiment structures a portion of result set 308 as relational data conforming to a certain set of relational table columns. Accordingly, application 310 includes structure specification according to data description language (DDL) syntax in metadata 318, to construct the table in a relational database. Consumer application 316 can use the DDL specification to construct the specified table using metadata 318 and populate the table with the portion of normalized result set 314.

In another embodiment, normalized result set 314 can also be represented as one or more data cubes 320. Data cube 320 includes all or a portion of normalized result set 314, and can be saved or cached for use in a future query. For example, query engine 306 can use data cube 320 in combination with amorphous data 304 for a future query. One example reason or logic for using data cube 320 in the combination may be that the same or similar data producers may be contributing input data for the future query, for a similar purpose or query as the one that produced result set 308, for the same or similar purpose as of consumer application as 316, or a combination thereof.

Parameters 322 include certain attributes associated with producer process 302. For example, as described earlier, the provenance attributed to producer process 302 can play a role in how consumer application 318 consumes normalized result set 314. Similarly, application 310 can use the provenance as a parameter in parameters 322, and can alter how result set 308 is normalized into normalized result set 314.

For example, in one embodiment, application 310 passes the provenance as a part of metadata 318. In another embodiment, application 310 uses the provenance from parameters 322 to select a structure to use for normalizing result set 308. For example, when application 310 receives different provenance values for different producers whose data is present in result set 308, application 310 can select a structure conforming to the data of the producer with the highest provenance to normalize the data from the producer of a lower provenance.

In another embodiment, application 310 can use a standards identifier as a parameter in parameters 322, and can alter how result set 308 is normalized into normalized result set 314. For example, different producers may contribute similarly purposed data to result set 308, however, their data may be organized differently from one another. For example, one producer may conform to a standard format specified for that type of data, whereas another producer may conform to a proprietary format for similar data.

In one embodiment, application 310 uses a formatting standard associated with the indicator passed as a parameter in parameters 322, to select a structure to use for normalizing result set 308. For example, application 310 may prefer a standards-based structure to a proprietary structure for normalizing result set 308.

Query engine 306 can also contribute a parameter to parameters 322. For example, when a query emphasizes a producer, data record, or a schema, an embodiment receives an indication of the emphasis as parameter 322. The embodiment construes such emphasis as an indication of a preference of consumer application 316. Accordingly, application 310 preferentially evaluates using a structure associated with the emphasized producer, record, or schema for normalizing result set 308 into normalized result set 314.

Under certain circumstances, consumer application 316 may have to perform further transformations on normalized result set 314. For example, consumer application 316 may have to perform further transformations on normalized result set 314 when the structure used in normalized result set 314 is different from the structure needed by consumer application 316. Under these and other similar circumstances, application 310 is configured to receive information 324 about the modifications made by consumer application 316.

In one embodiment, application 310 uses information 324 to normalize result set 308 differently in a next iteration of result set normalization, such as to produce a different structure suggested by information 324. In another embodiment, information 324 suggests certain markers in a given result set that should be emphasized, de-emphasized, prioritized, or considered differently for normalization in the next iteration. Application 310 uses the markers from information 324 to identify the structures for normalizing a result set the next time result set 308 is produced for consumer application 316.

The example of parameters 322 and information 324 are described only for the clarity of the description of several embodiments, and are not intended to be limiting on the illustrative embodiments. Those of ordinary skill in the art will be able to conceive from this disclosure many other parameters 322 and information 324 for similar purposes, and the same are contemplated within the scope of the illustrative embodiments.

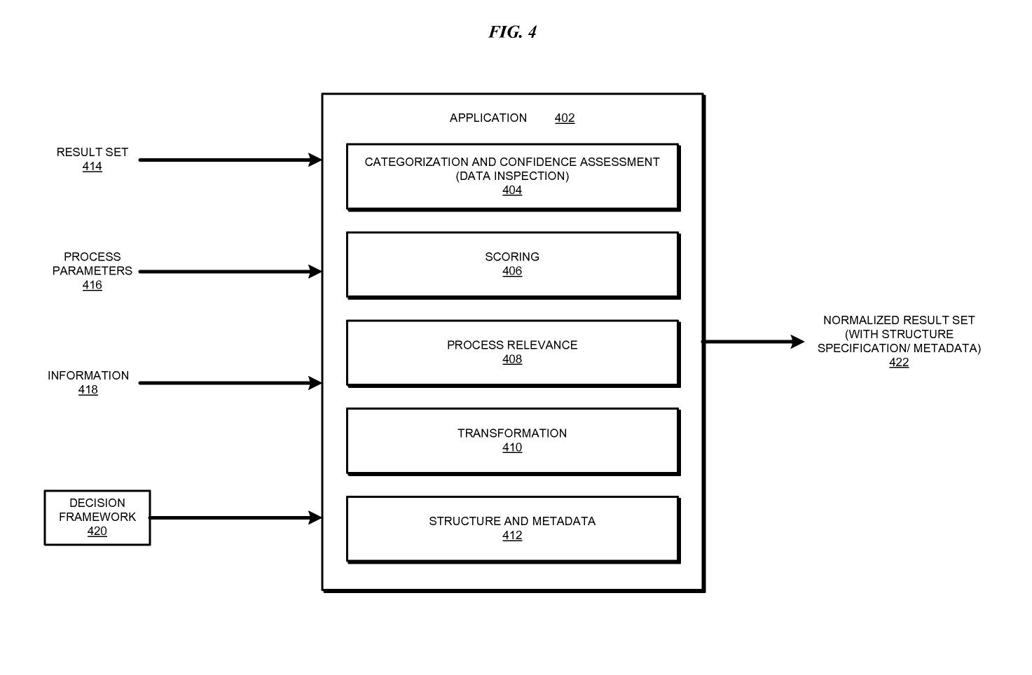

With reference to FIG. 4, this figure depicts a block diagram of an example application for normalizing amorphous query result sets in accordance with an illustrative embodiment. Application 402 is an example of application 310 in FIG. 3. Result set 414 is an example of result set 308 in FIG. 3. Parameters 416 and information 418 are analogous to parameters 322 and information 324, respectively, in FIG. 3. Decision framework 420 is an example of decision framework 312 in FIG. 3. Normalized result set 422 is an example of normalized result set 314 in FIG. 3.

Prior art data mapping technologies use pre-specified mapping rules to transform data from one presentation form to another. Furthermore, prior art data mapping technologies rely on pre-defined structures that are expected in input data, and pre-defined structures that are to be produced in the output data. Variance from the pre-defined structures is not easily handled without external logic or human intervention in the prior art data mapping technologies.

In contrast, an embodiment discovers the structural elements to be used for the normalization of the incoming data in the incoming data itself, by inspecting the incoming data. In other words, an embodiment does not use an externally defined pre-formed mapping or structural reference to read the incoming data and to produce normalized outgoing data. Instead, an embodiment uses a variety of techniques described herein to determine from the incoming data a structure most suitable for normalizing that incoming data under the conditions of the normalization.

Component 404 in application 402 categorizes portions of result set 414 according to the structures discovered within those portions. Component 404 categorizes the portions according to the structures exhibited by the portions, characteristics of the portion that lend the portion for structuring in a particular way, or a combination thereof. For example, component 404 may find that a portion of result set includes one or more records that are present in a relational form. Component 404 isolates those portions of result set 414 that conform to, or are conformable to, that relational form.

As another example, component 404 may find an amorphous portion in result set 414. The amorphous portion may contain cyclic dependencies within the portion. Accordingly, component 404 excludes XML or CSV as possible structures to normalize the amorphous portion. In one embodiment, component 404 may instead select an undirected graph, such as in RDF, as a suitable data format or structure to normalize the amorphous portion. In another embodiment, component 404 may select a relational structure to represent the amorphous portion with cyclic dependencies, such as when another portion of result set 414 is also a candidate for normalizing using a relational structure, as in the previous example of relational records.

Component 404 can identify the structure for normalizing a portion of result set 414 by inspecting the contents of the portion in question, the contents of other portions in result set 414, or a combination thereof. The logic to determine the structure in a portion is supplied from decision framework 420. For example, in the above example, component 404 detected a cyclic dependency in the data and based the structure determination on that detection.

The example logic to detect cyclic dependency or relational forms of data representation is not intended to be limiting on the illustrative embodiments. Many other structures exhibited in data or characteristics of data that lend the data for structuring in a particular way will be apparent from this disclosure to those of ordinary skill in the art, and the same are contemplated within the scope of the illustrative embodiments.

In one embodiment, component 404 also assigns a confidence level to the categorization. For example, in such an embodiment, component 404 implements a probabilistic classification technique that recommends a category for a given portion of result set 414 using structural characteristics provided by decision framework 420. For a given portion, the probabilistic classification technique categorizes the portion as suitable for normalizing using a particular structure with a degree of probability. The degree of probability is indicative of the confidence in the categorization given that portion and those structural characteristics.

Component 404 can thus categorize the same portion under different categories, to wit, as candidate for normalization using different structures, with differing confidence levels. In one embodiment, for a portion of result set 414, component 404 selects the categorization with the highest confidence level among all categories for that portion, and normalizes the portion using the structure of the selected category.

Under certain circumstances, a portion of result set 414 may lend itself for normalization in more than one ways. The above example where the amorphous portion can be normalized using undirected graph or relational representation illustrates this situation. Decision framework 420 provides logic to select amongst conflicting choices. For example, component 404 utilizes scoring component 406 to make the selection.

In one embodiment, decision framework 420 specifies a threshold size or percentage to select one structure over another. For example, in the above example of the amorphous portion, component 406 scores the amorphous portion of result set 414 to determine a percentage of data in that portion that lends itself to normalization using the undirected graph. Similarly, component 406 scores the amorphous portion of result set 414 to determine a percentage of data in that portion that lends itself to normalization using the relational structure. Whichever percentage meets or exceeds the threshold size or percentage, component 406 selects that structure for normalizing the portion of result set 414.

Component 406 scores one or more portions for one or more possible normalizing options in a similar manner. Depending on the scoring of component 406, component 404 performs the categorization described earlier.

Other factors can contribute or lend weight to categorization by component 404. For example, parameters 416 can guide the categorization process of component 404. Consider the provenance of a data producing process described earlier as an example parameter in parameters 416. Decision framework 420 provides rules or logic to determine when and how producer provenance should play a role in the categorization of a portion of result set 414.

For example, in one embodiment, process relevance component 408 uses the provenance as a tie breaker between two competing categorizations by choosing the category associated with the producer of higher provenance. In another embodiment, component 408 detects the structure used by the producer of a certain provenance and suggests the category to component 404.

As another example, consider the formatting standards and proprietary standards example described above. In one embodiment, parameters 416 include a parameter that indicates a formatting standard used by a producer. Decision framework 420 includes rules or logic to consider some standards, disregard other standards, and conditions when to consider certain other standards. Accordingly, component 408 evaluates the formatting standard indicator parameter in parameters 416, and determines a formatting standard to use in the categorization process. Component 408 then suggests the formatting standard to component 404 as a normalization option for a given portion.

As another example, consider information 418 in the manner described with respect to FIG. 3. For example, suppose that information 418 identifies a consumer application. Decision framework 420 includes rules or logic to incorporate markers previously identified by the consumer application into the categorization process. Decision framework 420 may also includes customer application preferences for normalization for various result sets 414. Accordingly, component 408 evaluates information 418 in view of the logic provided by decision framework 420. Component 408 then recommends a normalization structure (or the corresponding category) to use in the categorization process, the markers as categorization guides, or a combination thereof, to component 404. Component 404 then performs the categorization for the give result set 414 for the consumer identified in information 418.

Once the category, and the normalization structure corresponding there to, has been selected by component 404, transformation component 410 transforms, or normalizes, the portion of result set 414 according to that structure to produce normalized result set 422. Structure and metadata component 412 populate the metadata portion of normalized result set 422, such as metadata 318 in normalized result set 314 in FIG. 3.

In one embodiment, component 404, component 408, or a combination thereof can also modify a rule or logic in decision framework 420. For example, if component 404 detects a new structure, or a new marker for a structure in a given result set 414, component 404 can output a rule or code to decision framework 420, to associate the marker with the structure for future use. Similarly, if parameters 416, information 418, or a combination thereof suggests to component 408 a new structure or a new manner of normalization, component 408 can output the characteristics of the new structure to decision framework 420 for future use.

The components and their operations are described only to illustrate the operations executed of various embodiments. The specific component configuration depicted in FIG. 4 is not intended to be limiting on the illustrative embodiments. Furthermore, certain operations are described with respect to portions of result set 414 only as examples. An embodiment can treat a portion of result set 414 or entire result set 414 in the described manner within the scope of the illustrative embodiments.

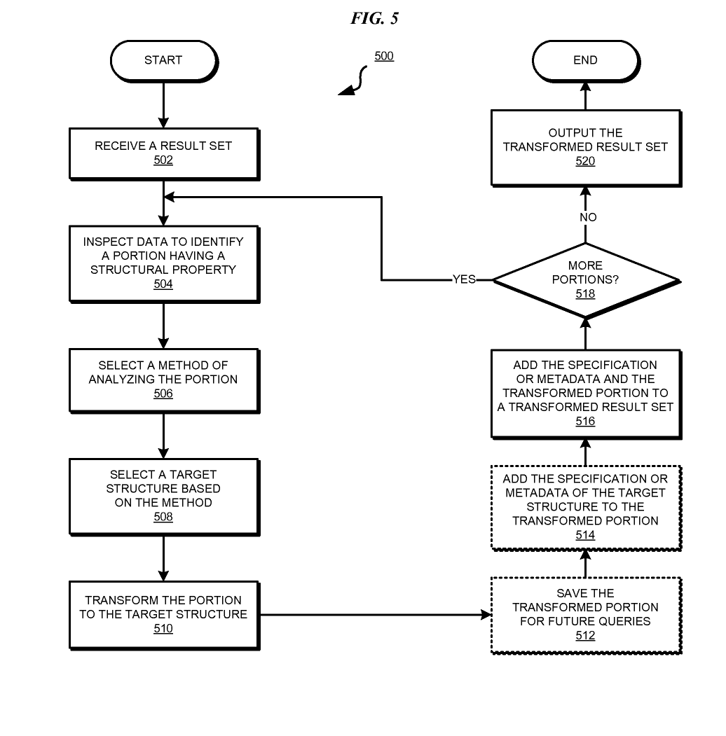

With reference to FIG. 5, this figure depicts a flowchart of an example process for normalizing amorphous query result sets in accordance with an illustrative embodiment. Process 500 can be implemented in application 402 in FIG. 4.

The application receives a result set, such as result set 414 in FIG. 4 (block 502). The application inspects the data in the result set to identify a portion having a structural property (block 504).

The application selects a method for analyzing the portion (block 506). For example, the application uses one or more methods, rules, or logic specified in decision framework 420 to categorize the portion.

The application selects a target structure for normalization of the portion according to the selected method (block 508). The application transforms, or normalizes, the portion to the target structure (block 510).

Optionally, the application saves the transformed portion for future queries, such as in the form of data cube 320 in FIG. 3 (block 512). Optionally, the application adds the specification of the target structure or other metadata to the transformed portion (block 514). The application adds the specification or the metadata and the transformed portion to a transformed result set, such as to normalized result set 422 in FIG. 4 or 314 in FIG. 3 (block 516).

The application determines whether more portions of the result set have to be transformed or normalized in a similar manner (block 518). If more portions have to be transformed (“Yes” path of block 518), the application returns to block 504. If no more portions have to be transformed (“No” path of block 518), the application outputs the transformed result set, such as to a consumer application (block 520). The application ends process 500 thereafter.

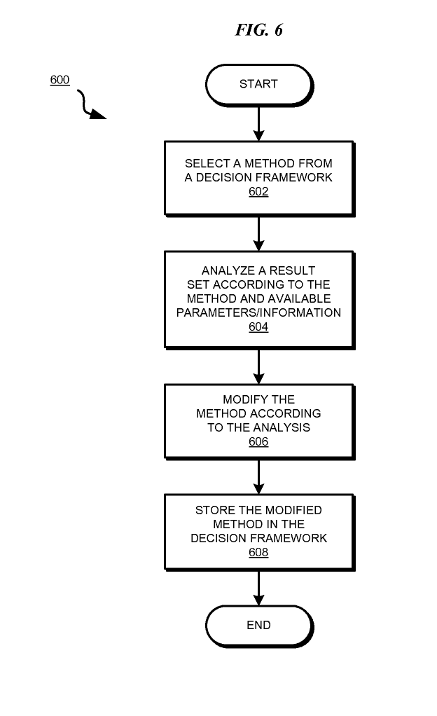

With reference to FIG. 6, this figure depicts a process for enriching a decision framework for normalizing amorphous query result sets in accordance with an illustrative embodiment. Process 600 can be implemented in application 402 in FIG. 4, such as in components 404, 408, or both.

The application begins process 600 by selecting a method from a decision framework (block 602). The application analyzes a result set according to the method (block 604). The application modifies the method, or creates a new method, according to the analysis and other available parameters and/or information, such as parameters 416 and information 418 in FIG. 4 (block 606). The application stores the modified method, or the new method, in the decision framework (block 608). The application ends process 600 thereafter.

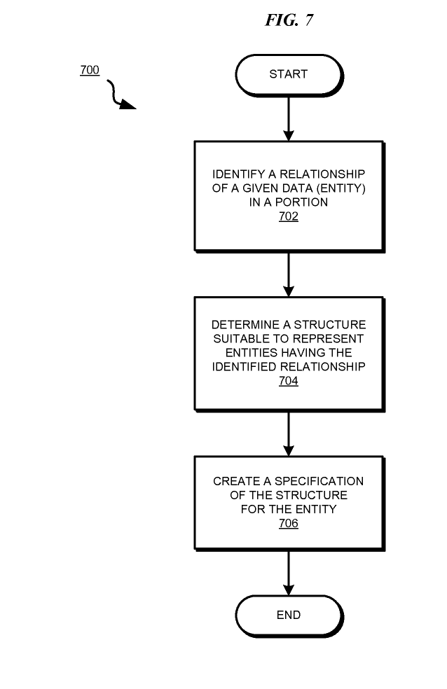

With reference to FIG. 7, this figure depicts a flowchart of an example process for identifying a structure by data inspection in accordance with an illustrative embodiment. Process 700 can be implemented in application 402 in FIG. 4.

The application begins process 700 by identifying a relationship of a given data with other data in a given result set (block 702). For example, if a data item is regarded as an entity within the result set or a portion thereof, an entity relationship diagram can be constructed between the data item and other data items in the result set. Based on the entity relationship diagram, a type of the entity as well as a structure to represent the related entities can be established using known methods.

The application determines a structure suitable for representing the entities in the identified relationships (block 704). The application creates a specification of the selected structure, for example, a DDL to create an example structure as a table in a relational database, (block 706). The application ends process 700 thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for normalizing amorphous query result sets.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable storage medium. A computer readable storage device may be, for example, but not limited to, an electronic, magnetic, optical, electromagnetic, or semiconductor system, apparatus, or device, or any suitable combination of the foregoing. More specific examples (a non-exhaustive list) of the computer readable storage device would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can store a program for use by or in connection with an instruction execution system, apparatus, or device. The term “computer readable storage device,” or variations thereof, does not encompass a signal propagation media such as a copper cable, optical fiber or wireless transmission media.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for normalizing an amorphous query result set, the method comprising:
identifying a property of data in a portion of the result set, wherein the property is usable for normalizing the portion into a structured data;
categorizing, into a first category, based on the property, the portion as a candidate for normalization using a first structure specification;
transforming, responsive to the first category being selected for normalizing the portion over a second category in an evaluation, the portion into the structured data according to the first structure specification of the first category;
adding the structured data and a metadata of structure specification to a normalized result set; and
outputting the normalized result set to a consumer application.

2. The method of claim 1, further comprising:
receiving a parameter associated with a producer of a data item in the result set;
categorizing, into the second category, based on the parameter, the portion as a candidate for normalization using a second structure specification;
evaluating the first and the second categories to determine a category to use for normalizing the portion; and
transforming, responsive to the second category being selected for normalizing the portion over the first category in the evaluation, the portion into the structured data according to the second structure specification of the second category.

3. The method of claim 2, wherein the parameter indicates a provenance of the producer.

4. The method of claim 1, wherein the property of the data is received from the consumer application as a categorization marker, wherein the marker is received from the consumer application for normalizing the result set in to a specific structured data required by the consumer application.

5. The method of claim 1, further comprising:
assigning a confidence level to the first category;
detecting another property of data in the portion;
categorizing the portion into a second category;
assigning a second confidence level to the second category; and
selecting, from the first and the second categories, a category corresponding to the higher of the first and the second confidence levels.

6. The method of claim 1, further comprising:
assigning a confidence level to the first category, wherein the confidence level is indicative of a probability that the property correctly categorizes the portion for normalization using the structure specification.

7. The method of claim 6, wherein the property is further usable for normalizing the portion into a second structured data according to a second structure specification with a second probability.

8. A computer program product comprising one or more computer-readable tangible storage devices and computer-readable program instructions which are stored on the one or more storage devices and when executed by one or more processors, perform the method of claim 1.

9. A computer system comprising one or more processors, one or more computer-readable memories, one or more computer-readable tangible storage devices and program instructions which are stored on the one or more storage devices for execution by the one or more processors via the one or more memories and when executed by the one or more processors perform the method of claim 1.

10. A computer program product for normalizing an amorphous query result set, the computer program product comprising:
one or more computer-readable tangible storage devices;
program instructions, stored on at least one of the one or more storage devices, to identify a property of data in a portion of the result set, wherein the property is usable for normalizing the portion into a structured data;
program instructions, stored on at least one of the one or more storage devices, to categorize, into a first category, based on the property, the portion as a candidate for normalization using a first structure specification;
program instructions, stored on at least one of the one or more storage devices, to transform, responsive to the first category being selected for normalizing the portion over a second category in an evaluation, the portion into the structured data according to the first structure specification of the first category;
program instructions, stored on at least one of the one or more storage devices, to add the structured data and a metadata of structure specification to a normalized result set; and
program instructions, stored on at least one of the one or more storage devices, to output the normalized result set to a consumer application.

11. The computer program product of claim 10, further comprising:
program instructions, stored on at least one of the one or more storage devices, to receive a parameter associated with a producer of a data item in the result set;
program instructions, stored on at least one of the one or more storage devices, to categorize, into the second category, based on the parameter, the portion as a candidate for normalization using a second structure specification;
program instructions, stored on at least one of the one or more storage devices, to evaluate the first and the second categories to determine a category to use for normalizing the portion; and
program instructions, stored on at least one of the one or more storage devices, to transform, responsive to the second category being selected for normalizing the portion over the first category in the evaluation, the portion into the structured data according to the second structure specification of the second category.

12. The computer program product of claim 11, wherein the parameter indicates a provenance of the producer.

13. The computer program product of claim 10, wherein the property of the data is received from the consumer application as a categorization marker, wherein the marker is received from the consumer application for normalizing the result set in to a specific structured data required by the consumer application.

14. The computer program product of claim 10, further comprising:
program instructions, stored on at least one of the one or more storage devices, to assign a confidence level to the first category;
program instructions, stored on at least one of the one or more storage devices, to detect another property of data in the portion;
program instructions, stored on at least one of the one or more storage devices, to categorize the portion into a second category;
program instructions, stored on at least one of the one or more storage devices, to assign a second confidence level to the second category; and
program instructions, stored on at least one of the one or more storage devices, to select, from the first and the second categories, a category corresponding to the higher of the first and the second confidence levels.

15. The computer program product of claim 10, further comprising:
program instructions, stored on at least one of the one or more storage devices, to assign a confidence level to the first category, wherein the confidence level is indicative of a probability that the property correctly categorizes the portion for normalization using the structure specification.

16. The computer program product of claim 15, wherein the property is further usable for normalizing the portion into a second structured data according to a second structure specification with a second probability.

17. A computer system for normalizing an amorphous query result set, the computer system comprising:
one or more processors, one or more computer-readable memories and one or more computer-readable tangible storage devices;
program instructions, stored on at least one of the one or more storage devices for execution by at least one of the one or more processors via at least one of the one or more memories, to identify a property of data in a portion of the result set, wherein the property is usable for normalizing the portion into a structured data;
program instructions, stored on at least one of the one or more storage devices for execution by at least one of the one or more processors via at least one of the one or more memories, to categorize, into a first category, based on the property, the portion as a candidate for normalization using a first structure specification;
program instructions, stored on at least one of the one or more storage devices for execution by at least one of the one or more processors via at least one of the one or more memories, to transform, responsive to the first category being selected for normalizing the portion over a second category in an evaluation, the portion into the structured data according to the first structure specification of the first category;
program instructions, stored on at least one of the one or more storage devices for execution by at least one of the one or more processors via at least one of the one or more memories, to add the structured data and a metadata of structure specification to a normalized result set; and
program instructions, stored on at least one of the one or more storage devices for execution by at least one of the one or more processors via at least one of the one or more memories, to output the normalized result set to a consumer application.

18. The computer system of claim 17, further comprising:
program instructions, stored on at least one of the one or more storage devices for execution by at least one of the one or more processors via at least one of the one or more memories, to receive a parameter associated with a producer of a data item in the result set;
program instructions, stored on at least one of the one or more storage devices for execution by at least one of the one or more processors via at least one of the one or more memories, to categorize, into the second category, based on the parameter, the portion as a candidate for normalization using a second structure specification;
program instructions, stored on at least one of the one or more storage devices for execution by at least one of the one or more processors via at least one of the one or more memories, to evaluate the first and the second categories to determine a category to use for normalizing the portion; and
program instructions, stored on at least one of the one or more storage devices for execution by at least one of the one or more processors via at least one of the one or more memories, to transform, responsive to the second category being selected for normalizing the portion over the first category in the evaluation, the portion into the structured data according to the second structure specification of the second category.

19. The computer system of claim 18, wherein the parameter indicates a provenance of the producer.

20. The computer system of claim 17, wherein the property of the data is received from the consumer application as a categorization marker, wherein the marker is received from the consumer application for normalizing the result set in to a specific structured data required by the consumer application.
